(19) United States
(12) Patent Application Publication
(10) Pub. No.: US 2013/0195427 A1
(43) Pub. Date: Aug. 1, 2013

(54) METHOD AND APPARATUS FOR DEVELOPING AND UTILIZING MULTI-TRACK VIDEO FILES

(71) Applicant: Sailesh Sathish, Tampere (FI)

(72) Inventor: Sailesh Sathish, Tampere (FI)

(73) Assignee: NOKIA CORPORATION, Espoo (FI)

(21) Appl. No.: 13/359,735

(22) Filed: Jan. 27, 2012

(51) Int. Cl. H04N 9/80

(52) U.S. Cl. 386/248; 386/E09.011

(57) ABSTRACT

Various methods for developing and utilizing multi-track video files are provided. One example method includes receiving a multi-track video file, determining at least one rule parameter, and determining a target track and an associated target video segment by applying the at least one rule parameter to the one or more rule definitions. The example method may further include causing playback of the target video segment. Similar and related example methods and example apparatuses are also provided.

### TECHNICAL FIELD

Embodiments of the present invention relate generally to the media content, and, more particularly, relate to methods and apparatuses for developing and utilizing multi-track video files.

### BACKGROUND

The revolution in wired and wireless communications technology has permitted network users to develop and share vast amounts of media content. Accessing video content via a network, which was once thought to require too much bandwidth to be feasible, is now mainstream, and there are a wide variety of media outlets on, for example, the Internet that provide video content. Media outlets not only cater to users' demands for commercially produced media, but also for amateur content. Additionally, due to the evolution of wireless networks and handheld computing, video content is now portable and can be enjoyed by users in just about any setting. With these new and convenient ways to obtain video content, users are continuing to demand more innovative and dynamic ways to develop and present video content to enhance the user experience and leverage video content in new and unique applications.

### BRIEF SUMMARY

Example methods and example apparatuses for developing and utilizing multi-track video files are provided. One example method may include receiving a multi-track video file comprising a plurality of alternative video tracks and one or more rule definitions. The plurality of alternative video tracks may include at least a first video track and a second video track, wherein a first video segment on the first video track presents a different video scene than a second video segment on the second video track. The example method may also include determining at least one rule parameter, and determining a target track and an associated target video segment selected from the plurality of alternative video tracks by applying the at least one rule parameter to the one or more rule definitions. The target video track may be one of the plurality of alternative video tracks. The example method may further include causing playback of the target video segment.

An additional example embodiment is an apparatus comprising at least one processor and at least one memory including computer program code. The at least one memory and the computer program code may be configured to, with the at least one processor, direct the example apparatus to perform various functionality. In this regard, the example apparatus may be directed to perform receiving a multi-track video file comprising a plurality of alternative video tracks and one or more rule definitions. The plurality of alternative video tracks may include at least a first video track and a second video track, wherein a first video segment on the first video track presents a different video scene than a second video segment on the second video track. The example apparatus may be further directed to perform determining at least one rule parameter, and determining a target track and an associated target video segment selected from the plurality of alternative video tracks by applying the at least one rule parameter to the one or more rule definitions. The target video track may be one of the plurality of alternative video tracks. The example apparatus may be further directed to perform causing playback of the target video segment.

Another example embodiment is an example non-transitory computer readable medium having computer program code stored thereon. When executed, the computer program may direct an apparatus to perform receiving a multi-track video file comprising a plurality of alternative video tracks and one or more rule definitions. The plurality of alternative video tracks may include at least a first video track and a second video track, wherein a first video segment on the first video track presents a different video scene than a second video segment on the second video track. The computer program may also direct the apparatus to perform determining at least one rule parameter, and determining a target track and an associated target video segment selected from the plurality of alternative video tracks by applying the at least one rule parameter to the one or more rule definitions. The target video track may be one of the plurality of alternative video tracks. The computer program may also direct the apparatus to perform causing playback of the target video segment.

Another example embodiment is an apparatus comprising means for receiving a multi-track video file comprising a plurality of alternative video tracks and one or more rule definitions. The plurality of alternative video tracks may include at least a first video track and a second video track, wherein a first video segment on the first video track presents a different video scene than a second video segment on the second video track. The example apparatus may further include means for determining at least one rule parameter, and means for determining a target track and an associated target video segment selected from the plurality of alternative video tracks by applying the at least one rule parameter to the one or more rule definitions. The target video track may be one of the plurality of alternative video tracks. The example apparatus may further include means for causing playback of the target video segment.

### BRIEF DESCRIPTION OF THE DRAWING(S)

Having thus described the invention in general terms, reference will now be made to the accompanying drawings, which are not necessarily drawn to scale, and wherein:

FIG. 1 illustrates an example multi-track file according to various example embodiments;

FIG. 2 illustrates playback of a video segment on Track 1 of the multi-track video file of FIG. 1 according to various example embodiments;

FIG. 3 illustrates playback of a video segment on Track 3 of the multi-track video file of FIG. 1 according to various example embodiments;

FIG. 4 illustrates playback of a video segment on Track 1 interrupted by playback of a video segment on Track 4 of the multi-track file of FIG. 1 according to various example embodiments;

FIG. 5 illustrates an example framework for supporting multi-track video files according to various example embodiments;

FIG. 6 illustrates a block diagram of an example apparatus configured to support multi-track video files according to various example embodiments;

FIG. 7 illustrates a block diagram of an example mobile terminal configured support multi-track video files according to various example embodiments; and

FIG. 8 illustrates a flowchart of an example method for playback of a multi-track video file according to various example embodiments.

### DETAILED DESCRIPTION

Example embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout. The terms “data,” “content,” “information,” and similar terms may be used interchangeably, according to some example embodiments of the present invention, to refer to data capable of being transmitted, received, operated on, and/or stored.

As used herein, the term ‘circuitry’ refers to all of the following: (a) hardware-only circuit implementations (such as implementations in only analog and/or digital circuitry); (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions); and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device. The term “video” as used herein may be construed to include only video, or video with audio.

According to various example embodiments, methods and apparatuses are provided herein that support the generation or playback of multi-track video files. A multi-track video file may be a collection of data that can be rendered or played for presentation to a user on a display device. As the name implies, a multi-track video file may include a plurality of tracks including two or more video tracks and at least one rules track. Each video track of a multi-track video file may include a video segment, and the video segment may include video data and, in some instances, audio data that, when played, provides media content to a user. A video segment may be a video recording or other generated video content (e.g., cartoons, slide presentations, or the like). A content author or a video producer may generate the various video segments as different or alternative video scenes and add the video segments to respective tracks of the multi-track video file. Video editing software or other techniques may be used to generate the multi-track video file, which may be supported by various media playback engines. The video segments may be broken into frames which may be sub-portions of the video segment.

The content of video tracks of a multi-track video file may be presented in the alternative. In this regard, a multi-track video file with two video tracks may be played and present the video segment of track 1 or the video segment of track 2. The video tracks may therefore be used to present respective video segments that are defined to provide different video scenes. In this regard, the different video scenes provided in video segments of different tracks may include different content, and not merely a different quality variation of the same content. For example, a video scene of the video segment on a first track may present an event from a first perspective and a different video scene of the video segment on a second track may present the event from a second, different perspective. Alternatively, the video segments on the first and second tracks may provide different video scenes, where a first video scene may be an advertisement with a spokesperson that is an athlete and a different video scene from a video segment on a different video track may be an advertisement with a spokesperson that is an entertainer. Alternatively, the video segments on the first and second tracks may provide different video scenes where a first video scene may be appropriate for children and a different video scene from a video segment on a different video track may be appropriate for adults.

The video segments from each track need not be complete alternative segments. In this regard, the video segment on a first video track may be a 30 second video scene. However, the video segment on the second video track may be a 10 second video scene that can optionally replace 10 seconds of the 30 second video scene in the video segment on the first track. In this regard, during playback a first sequence of frames may be taken from the first track, a second sequence of frames may be taken form the second track, and a third sequence of frames may be taken from the first track.

To determine which track should be presented during playback of the multi-track media file, rule definitions may be applied to rule parameters. The rule definitions may be a collection of criteria that, when considered in view of a collection of rule parameter values, indicate which of the plurality of alternative video tracks to play. In other words, the rule definitions may act as control logic for determining which track to play based on the collection of rule parameters. As such, the rule parameters may be applied to the one or more rule definitions to identify a target video track and an associated target video segment. In some example embodiments, the rule definitions may reside in a rules track of the multi-track video file. Accordingly, the rules track of the multi-track video may be accessed to load the rule definitions and consider the rule parameters in view of the rule definitions.

The rule definitions may consider a variety of rule parameters to indicate which track to be played. In this regard, the rule definitions may consider rule parameters that describe a user's context (e.g., the user's location, the current time, the user's proximity to other identified users or friends, or the like). Information for the rule parameters may be gathered or received in a variety of ways, including via sensor on the mobile terminals. The context information may be considered as rule parameters and applied to the rule definitions to determine a target video track. Additionally, or alternatively, user preferences may be considered. In this regard, a user may provide input indicating the user's preferences or the user's preferences may otherwise be derived from, for example, frequent activities, favorite websites, profile information, or the like. These preferences may be considered as rule parameters and applied to the rule definitions to determine a target track.

The analysis that is undertaken to determine a target track based on the rule parameters and rule definitions may be conducted prior to the playback of a target track and playback may proceed to the end of the video segment for that track, without further consideration of changes to the rule parameters. In some instances, the analysis of the rule parameters that is undertaken prior to playback of the multi-track video file may indicate that multiple tracks may be involved in the playback. For example, the analysis of the rule parameters may indicate that a first track is to be played for a first frame, a second track is to be played for the second through fourth frames, and the first track is to be played for the fifth and sixth frame. In this manner, the content of the complete playback may involve multiple tracks and may be determined in advance of beginning playback.

However, in some example embodiments, the analysis may be conducted continuously, for example, at regular intervals, even after a target track for a given multi-track video file has been identified and playback of the video segment on the target track has begun. By continuously analyzing the rule parameters against the rule definitions, a device may determine that the rule parameters have changed such that a different track has become the target track. Accordingly, at an appropriate time in the playback of the multi-track video file (e.g., a scene change) playback may transition from a first track to a second track, even though playback of the video segment on the first track was not complete. By implementing these mid-video segment playback transitions, the multiple tracks of a multi-track video file can be used dynamically to provide the most appropriate content at any given time based on changing rule parameters. Additionally, these mid-video segment playback transitions can provide a variety of user experiences with the same video file because a sense of unpredictability is provided by the track transitions.

In example embodiments that implement dynamic selection, an engine that processes the control logic of the rule definitions may be integrated with a media engine, thereby allowing rapid response to changes in the target track due to changes in the rule parameters. Further, when a dynamic determination of the target track is being implemented, as provided above, the rule set does not need to be placed in the exact time window or frame for the respective rule parameter analysis. Rather, according to some example, the rule definitions may include frame references that indicate the frame or frame sets where alternate tracks are available. Since the frames may have the same timing between the tracks, the timing of the frames can be leveraged for transitions between the tracks.

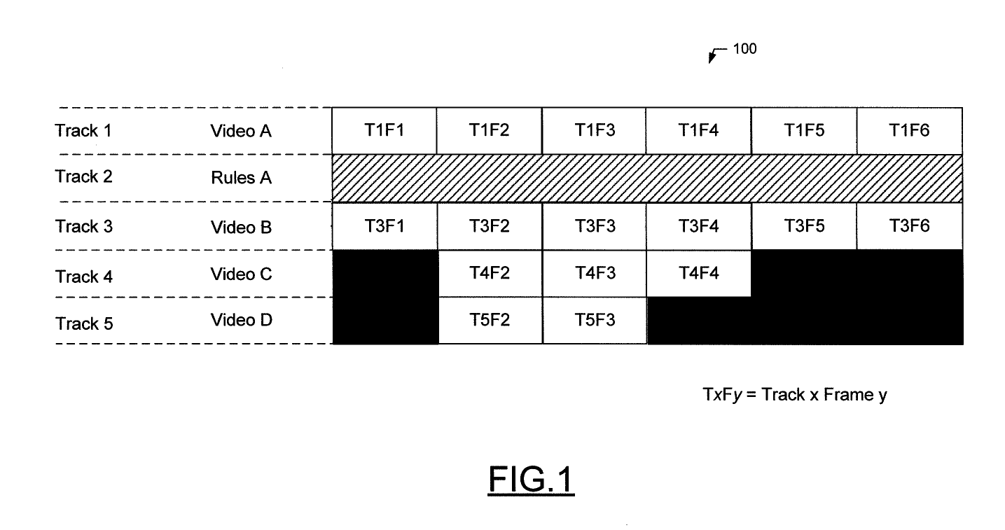

FIG. 1 illustrates an architecture of an example multi-track video file 100 according to some example embodiments. The multi-track video file 100 includes five tracks, where four of the tracks are used for alternative video segments (Tracks 1, 3, 4, and 5) and on is used for rules (Track 2). In this regard, Track 1 includes a Video Segment A; Track 2 includes Rules Definitions A; Track 3 includes Video Segment B; Track 4 includes Video Segment C; and Track 5 includes Video Segment D. Each of the video segments for a respective track may be sub-divided into timing frames. Video Segment A includes six frames; Video Segment B includes six frames; Video Segment C includes three frames; and Video Segment D includes two frames. The black space in Track 4 and 5 indicates that no video data is provided in those frame positions.

According to some example embodiments, the architecture of the multi-track video file may be backwards compatible for media players that do not support multi-track video files. In this regard, one of the tracks, for example, Track 1, may be defined such that the track is a default track that would be recognized by media players that may not support multi-track video operation. The non-default tracks of the multi-track video file may be defined such that media players that may not support multi-track operation may ignore or otherwise not consider the non-default tracks.

The use of frames in the video segments can facilitate the ability to transition from playback of a video segment on a first track to playback of a video segment on a second track. The frames may be defined such that the frames have a temporal relationship. As indicated in FIG. 1, for each of the video tracks, Frame 2 may be played at the completion of Frame 1. As such, because the timing of the frames is related, the mid-video segment transition to a video segment on another track can occur at a frame break, thereby creating the appearance of seamless video playback despite the transitions between video segments on different tracks.

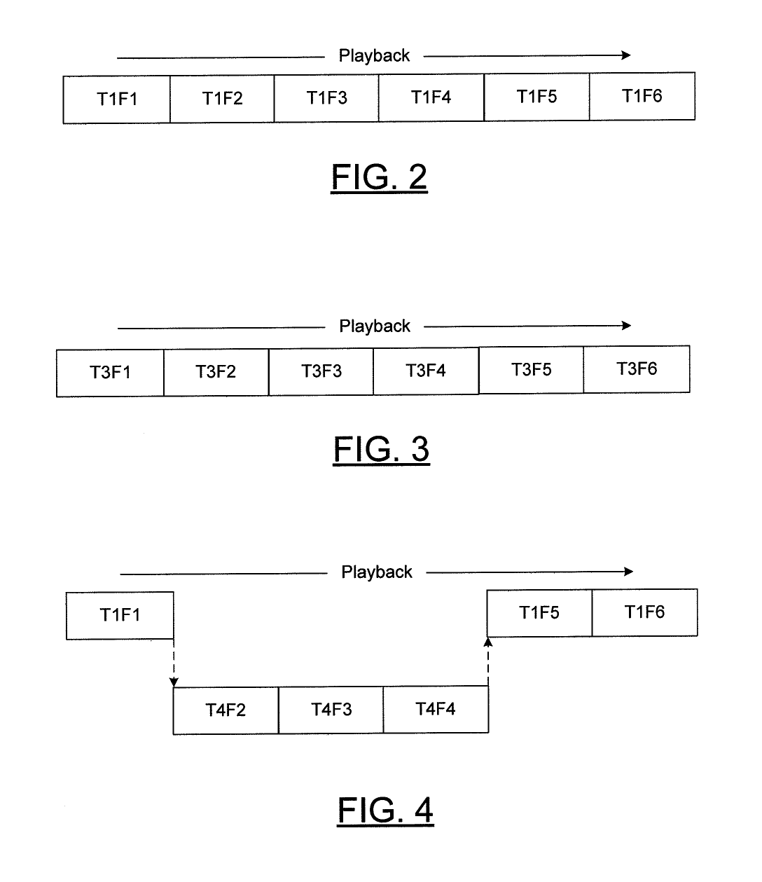

FIGS. 2 through 4 illustrate example playback scenarios for the multi-track video file 100. For each scenario, rule parameter information can be obtained and applied to the rule definitions provided in the Rules Definitions A of Track 2. As a result, a target track may be determined and playback of an associated video segment may begin.

In FIG. 2, an analysis of the rule parameters against the rule definitions has determined that Track 1 is the target video track, and therefore playback of Video Segment A may be performed. The determination that Track 1 is the target track has occurred prior to playback of the multi-track video file. Additionally, accordingly to some embodiments, it can be assumed that if continuous analysis of the rule parameters is being performed, and no change in the target track has resulted, then playback of the Video Segment A is performed from Frame 1 to Frame 6.

In FIG. 3, an analysis of the rule parameters against the rule definitions has determined that Track 3 is the target video track, and therefore playback of Video Segment B may be performed. The determination that Track 3 is the target track has occurred prior to playback of the multi-track video file. Additionally, accordingly to some embodiments, it can be assumed that if continuous analysis of the rule parameters is being performed, and no change in the target track has resulted and playback of the Video Segment B is performed from Frame 1 to Frame 6.

In FIG. 4, an analysis of the rule parameters against the rule definitions may have determined that Track 1 is the target video track, and therefore playback of Video Segment A may be performed. During playback of Video Segment A, the rule parameters may be evaluated and a determination may be made that a transition to Track 4 should occur. As depicted in FIG. 4, a transition from Track 1 to Track 4 may occur after playback of the first frame is complete. Subsequently, the three frames of Video Segment C on Track 4 may be played. Playback may then revert back to Track 1 because playback of Video Segment C is complete (e.g., Video Segment C has no remaining frames), and Video Segment A has remaining frames. Alternatively, another analysis of the rule parameters may indicate that playback should transition to Track 1 after Frame 4.

Furthermore, regarding FIG. 4, the transitions from Track 1 to Track 4 and from Track 4 to Track 1 may be determined in advance to any playback of the multi-track video file. In this regard, a pre-playback determination may be made based on the rule parameters to play Frame 1 of Track 1, Frames 2-4 of Track 4, and Frames 5 and 6 of Track 1. This sequence may then be played without relying on further analysis of the rule parameters during playback.

According to various example embodiments, the rule definitions may be formulated in a variety of ways and may be based on any type of criterion. Further, any number of rule definitions may be stored on a rules track and rule definitions may be defined such that the rule definitions are interrelated (i.e., a tree structure). The rule definitions may also be defined in accordance with selection conditions, nesting attributes, cross-referral rules, and external context access

Further, according to some example embodiments, a multi-track video file may have multiple rule definition tracks. In some example embodiments, each video track may have a respective rules track. Additionally or alternatively, a track number, a rule identifier, or a combination of both may be assigned to uniquely identify each rule.

According to some example embodiments, the rule definitions may define different modes of operation for determining a target track. In this regard, an operational mode may be a random mode where a target track determination may be made randomly (or pseudo-randomly) or at least determined randomly from a subset of the video tracks. Alternatively, a sequential mode may be defined and utilized where each time the multi-frame video file is played, the next track in a defined sequence is played. In some example embodiments, a tapering mode may be implemented. Further, according to some embodiments, a choice mode may be implemented where a selection of the desired track is received from a user and played. Other user preferences that are input or previously defined or derived may also be considered when determining a target track. In some example embodiments, the rules may be defined such that the number of times that the multi-track video file has been played (as a rule parameter) is considered when determining the target track. Further, the rule definitions may consider contextual and presence information about the user and a user's device (e.g., a smart phone or the like) when determining a target track. With respect to context, rule definitions may refer to proximal context (e.g., within a threshold distance to the device) or external context by connecting to any external service to obtain data, for example, via the Internet. Rules may also be defined such that a version number of the multi-track media file is considered or if the type of rules that are defined can be supported by the device that is determining the target track.

Another form of rule definitions may be based on user preferences. Preferences may be specified generally (e.g., across multiple tracks) or more specifically relating to certain tracks using track names as identifiers. The utilization of rule definitions based on user preferences may be applicable to multi-track video files, and rule definitions of this type may be optionally supported by media player vendors. A rule definition based on user preferences may be considered in target track determinations as otherwise described herein. In some example embodiments, the rule parameters that are applied against the rule definitions to determine a target track may be received via a user interface of an input device. Further, in some example embodiments, the user preferences may, in some instance, override other track specific rule definitions. Other preferences could be viewing modes. Examples are adult-individual mode (adult content is allowed), family mode (no adult content), child mode (only children content) etc.

The following provides one example set of rule definitions that may be included on the rules track. This example set is provided in an extensible markup language (XML), however, any format for providing the rule definitions may be used.

### Example Set of Rule Definitions

```
<selectionRule id=1 track=2>
<frameSegment range=2-4>
<select track=3>
    <priority>none</priority> //no particular priority to this rule
    <condition> //condition for selecting track 3
      <playbackNumber parent=3/> //parent is main track- play
      this if the //main
      track has been viewed at least 3 times by viewer
      <switch track=4> //switch to track 4
      <playBackNumber track=this>4</playbackNumber> //if playback
      //exceeded 4 times
      </switch>
    </condition>
</select>
<select track=4>
  <priority>l</priority> //rule to be given highest priority overriding others
  <condition>
  <context>
    <heartRate above=200/> //if user heart rate (from heart
    rate monitor) is above 200
    (//use in an exercise video for example to raise or lower heart rate)
    //others: temperature, presence of family (skip over an adult
    section), location
    (location based showing of an //alternative video segment
  </context>
  </condition>
</select>
<select track=5>
  <priority> 3 </priority>
  <condition>
  ........
  ........
  <rule track=6 id=2/> //after conditions are satisfied, use
  </condition>
</select>
</frameSegment>
</selectionRule>
```

In addition to including rules definitions on the rule track, information about each of the alternative video segments on the respective track may be provided in the rule track. This information may be leveraged for either automated or user selection of tracks. This information may specify, a resolution of each of the alternate video tracks, an angle of capture of a video track (e.g., wide angle video), an orientation of the video scene, or a location associated with each respective video segment (e.g., global positioning system coordinates). The following is an example track information set.

### Example Track Information Set

```
<selectionRule id=2 track=2>
<frameSegment range=2-4>
<track-info>
  <track no=3 type=wideAngle/>
<track no=4>
  <orientation>...</orientation>
  <location>...</location>
</track
</track-info>
  <select track=* type =random/>
</frameSegment>
</selectionRule>
```

The preceding track information set includes a track-info tag that can be included within the frameSegment and a selectionRule tag, outside a selectionRule tag, or outside a frameSegment tag. If the track-info tag is included outside the frameSegment tag, the track-info may be applicable for some or all segments included within that track and not only for the segment in the range parameter within frameSegment tag. If global (e.g., outside frameSegment) track info is provided, the information may be overridden by indicating specific track segment information and by including the information within the corresponding frameSegment tag.

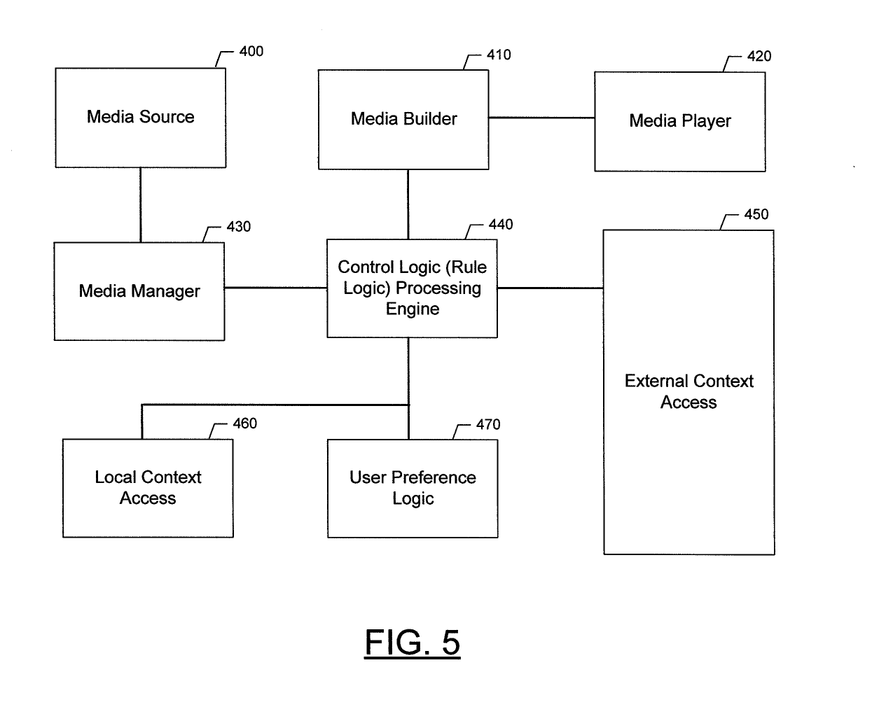

Various implementation frameworks may be utilized to implement some of the example embodiments described above. One example framework is provided in FIG. 5. The example framework of FIG. 5 may be implemented by processing circuitry configured, possibly via software, to implement a framework for handling multi-track video files as described above. In this regard, the media manager 430 may receive a multi-track video file from the media source 400 and may select the rule tracks from a given multi-track video file. The media manager 430 may also request that the control logic 440 process the rule definitions. The control logic 440 may also receive various rule parameters for application to the rule definitions. In this regard, the control logic 440 may also use input from local context access module 460, which may be inclusive of a device profile. In some example embodiments, the control logic 440 may additionally or alternatively use input from the external context access 450 (e.g., input indicating the weather conditions outside or the seasons). The control logic 440 may also consider user preferences into account that may override track specific selection logic.

Based on the various rule parameters, the control logic 440 may determine a target track or collection of tracks. The target track may be sent to the media builder 410 which may, for example, prepare the target track for playback by combining video segments and portions of video segments as appropriate. The resultant video content may be provided to the media player 420 for playback.

It is to be noted that the framework shown FIG. 5 depicts a non-integrated version of the media player and control logic. This implementation may be manageable with respect to modularized upgrades and faster processing. In some example embodiments, the control logic 440 may be processed by a separate chip set or even a common XML engine available on the device.

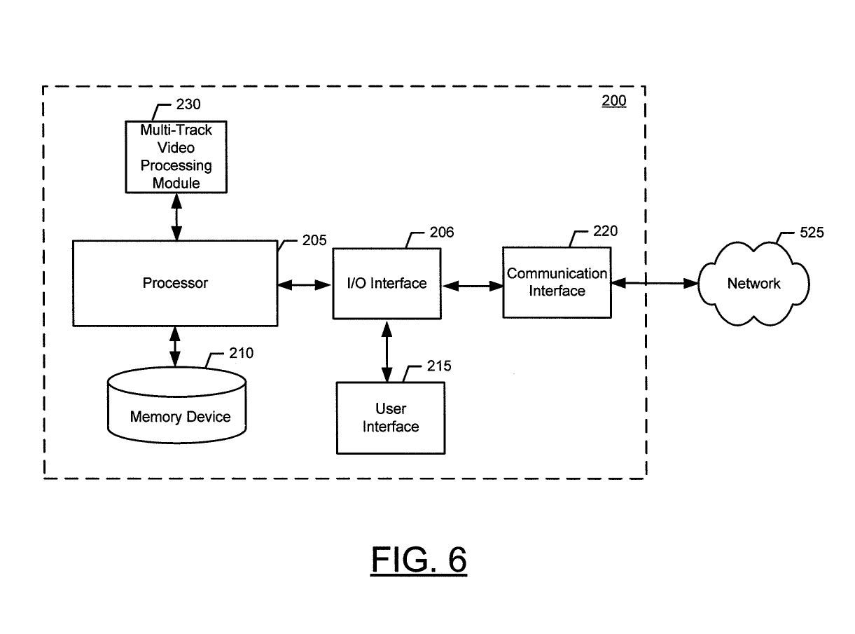

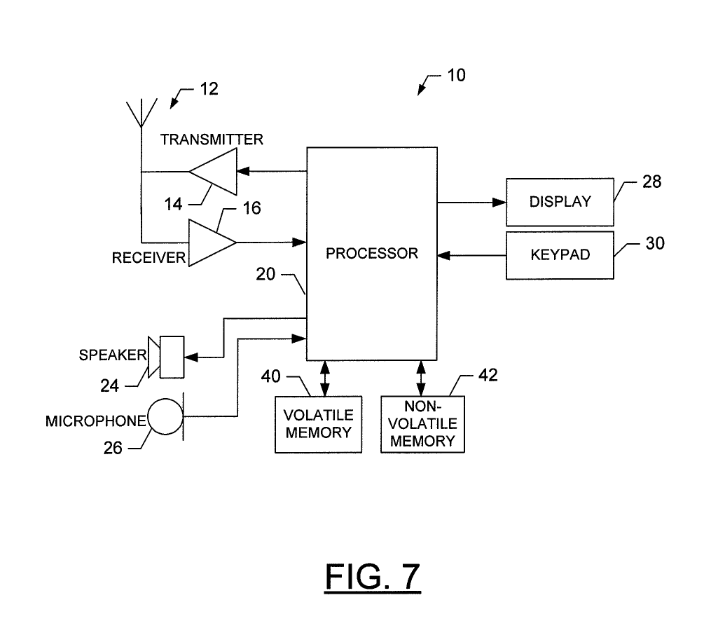

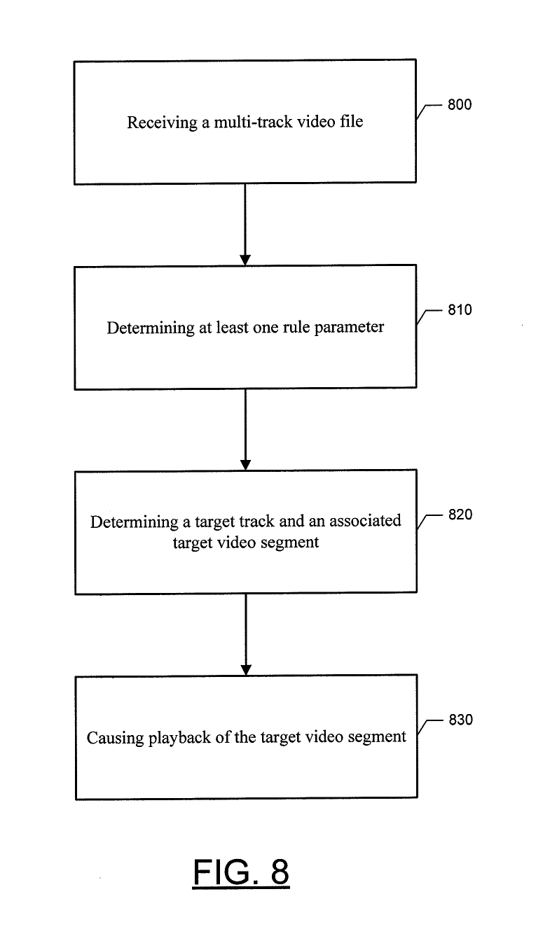

The description provided above and generally herein illustrates example methods, example apparatuses, and example computer programs stored on a non-transitory computer readable media for generating and utilizing multi-frame video files. FIGS. 6 and 8 illustrate example apparatus embodiments configured to perform the various functionalities described herein. FIG. 6 depicts an example apparatus that is configured to perform various functionalities as described with respect to FIGS. 1-5 and as generally described herein. FIGS. 7 depicts an example apparatus in the form of a more specific mobile terminal configured to perform various functionalities as described with respect to FIGS. 1-5 and as generally described herein. The example apparatuses depicted in FIGS. 6 and 7 may also be configured to perform example methods of the present invention, such as those described with respect to FIG. 8.

Referring now to FIG. 6, in some example embodiments, the apparatus 200 may, be embodied as, or included as a component of, a communications device with wired and/or wireless communications capabilities. In some example embodiments, the apparatus. 200 may be part of a communications device, such as a stationary or a mobile terminal. As a mobile terminal, the apparatus 200 may be a mobile computer, mobile telephone, a portable digital assistant (PDA), a pager, a mobile television, a gaming device, a mobile computer, a laptop computer, a camera, a video recorder, an audio/video player, a radio, smart phone, tablet or pad device and/or a global positioning system (GPS) device, any combination of the aforementioned, or the like. Regardless of the type of communications device, apparatus 200 may also include computing capabilities.

The example apparatus 200 may includes or is otherwise in communication with a processor 205, a memory device 210, an Input/Output (I/O) interface 206, a communications interface 220, user interface 215, and a multi-track video processing module 230. The processor 205 may be embodied as various means for implementing the various functionalities of example embodiments of the present invention including, for example, a microprocessor, a coprocessor, a controller, a special-purpose integrated circuit such as, for example, an ASIC (application specific integrated circuit), an FPGA (field programmable gate array), or a hardware accelerator, processing circuitry or the like. According to one example embodiment, processor 205 may be representative of a plurality of processors, or one or more multiple core processors, operating in concert. Further, the processor 205 may be comprised of a plurality of transistors, logic gates, a clock (e.g., oscillator), other circuitry, and the like to facilitate performance of the functionality described herein. The processor 205 may, but need not, include one or more accompanying digital signal processors. In some example embodiments, the processor 205 is configured to execute instructions stored in the memory device 210 or instructions otherwise accessible to the processor 205. The processor 205 may be configured to operate such that the processor causes the apparatus 200 to perform various functionalities described herein.

Whether configured as hardware or via instructions stored on a computer-readable storage medium, or by a combination thereof, the processor 205 may be an entity capable of performing operations according to embodiments of the present invention while configured accordingly. Thus, in example embodiments where the processor 205 is embodied as, or is part of, an ASIC, FPGA, or the like, the processor 205 is specifically configured hardware for conducting the operations described herein. Alternatively, in example embodiments where the processor 205 is embodied as an executor of instructions or computer program code stored on a non-transitory computer-readable storage medium, the instructions specifically configure the processor 205 to perform the algorithms and operations described herein (e.g., those described with respect to FIG. 8). In some example embodiments, the processor 205 is a processor of a specific device (e.g., a mobile terminal) configured for employing example embodiments of the present invention by further configuration of the processor 205 via executed instructions for performing the algorithms, methods, and operations described herein.

The memory device 210 may be one or more non-transitory computer-readable storage media that may include volatile and/or non-volatile memory. In some example embodiments, the memory device 210 includes Random Access Memory (RAM) including dynamic and/or static RAM, on-chip or off-chip cache memory, and/or the like. Further, memory device 210 may include non-volatile memory, which may be embedded and/or removable, and may include, for example, read-only memory, flash memory, magnetic storage devices (e.g., hard disks, floppy disk drives, magnetic tape, etc.), optical disc drives and/or media, non-volatile random access memory (NVRAM), and/or the like. Memory device 210 may include a cache area for temporary storage of data. In this regard, some or all of memory device 210 may be included within the processor 205.

Further, the memory device 210, which may be one or more memory devices, may be configured to store information, data, applications, computer-readable program code instructions, and/or the like for enabling the processor 205 and the example apparatus 200 to carry out various functions in accordance with example embodiments of the present invention described herein. For example, the memory device 210 could be configured to buffer input data for processing by the processor 205. Additionally, or alternatively, the memory device 210 may be configured to store instructions for execution by the processor 205.

The I/O interface 206 may be any device, circuitry, or means embodied in hardware, software, or a combination of hardware and software that is configured to interface the processor 205 with other circuitry or devices, such as the communications interface 220 and the user interface 215. In some example embodiments, the processor 205 may interface with the memory 210 via the I/O interface 206. The I/O interface 206 may be configured to convert signals and data into a form that may be interpreted by the processor 205. The I/O interface 206 may also perform buffering of inputs and outputs to support the operation of the processor 205. According to some example embodiments, the processor 205 and the I/O interface 206 may be combined onto a single chip or integrated circuit configured to perform, or cause the apparatus 200 to perform, various functionalities of the present invention.

The communication interface 220 may be any device or means (e.g., circuitry) embodied in hardware, a computer program product, or a combination of hardware and a computer program product that is configured to receive and/or transmit data from/to a network 225 and/or any other device or module in communication with the example apparatus 200. The communications interface may be configured to communicate information via any type of wired or wireless connection, and via any type of communications protocol, such as a communications protocol that supports cellular communications or near field communications. According to various example embodiments, the communication interface 220 may be configured to support the transmission and reception of communications in a variety of networks including, but not limited to Internet Protocol-based networks (e.g., the Internet), cellular networks, or the like. Further, the communications interface 220 may be configured to support device-to-device communications, such as in a mobile ad hoc network (MANET). Processor 205 may also be configured to facilitate communications via the communications interface 220 by, for example, controlling hardware comprised within the communications interface 220. In this regard, the communication interface 220 may comprise, for example, communications driver circuitry (e.g., circuitry that supports wired communications via, for example, fiber optic connections), one or more antennas, a transmitter, a receiver, a transceiver and/or supporting hardware, including, for example, a processor for enabling communications. Via the communication interface 220, the example apparatus 200 may communicate with various other network entities in a device-to-device fashion and/or via indirect communications via a base station, access point, server, gateway, router, or the like.

The user interface 215 may be in communication with the processor 205 to receive user input via the user interface 215 and/or to present output to a user as, for example, audible, visual, mechanical or other output indications. The user interface 215 may include, for example, a keyboard, a mouse, a joystick, a display (e.g., a touch screen display), a microphone, a speaker, or other input/output mechanisms. Further, the processor 205 may comprise, or be in communication with, user interface circuitry configured to control at least some functions of one or more elements of the user interface. The processor 205 and/or user interface circuitry may be configured to control one or more functions of one or more elements of the user interface through computer program instructions (e.g., software and/or firmware) stored on a memory accessible to the processor 205 (e.g., volatile memory, non-volatile memory, and/or the like). In some example embodiments, the user interface circuitry is configured to facilitate user control of at least some functions of the apparatus 200 through the use of a display and configured to respond to user inputs. The processor 205 may also comprise, or be in communication with, display circuitry configured to display at least a portion of a user interface, the display and the display circuitry configured to facilitate user control of at least some functions of the apparatus 200.

The multi-track video processing module 230 of example apparatus 200 may be any means or device embodied, partially or wholly, in hardware, a non-transitory computer readable medium having a computer program stored thereon, or a combination of hardware and a non-transitory computer readable medium having a computer program stored thereon, such as processor 205 implementing stored instructions to configure the example apparatus 200, or a hardware configured processor 205, that is configured to carry out the functions of the multi-track video processing module 230 as described herein. In an example embodiment, the processor 205 includes, or controls, the multi-track video processing module 230. The multi-track video processing module 230 may be, partially or wholly, embodied as processors similar to, but separate from processor 205. In this regard, the remote UI server module 230 may be in communication with the processor 205. In various example embodiments, the multi-track video processing module 230 may, partially or wholly, reside on differing apparatuses such that some or all of the functionality of the multi-track video processing module 230 may be performed by a first apparatus, and the remainder of the functionality of the multi-track video processing module 230 may be performed by one or more other apparatuses.

The apparatus 200 and the processor 205 may be configured to perform the following functionality via the multi-track video processing module 230. In some example embodiments, via the multi-track video processing module 230, the processor 205 may be configured to cause the apparatus 200 to implement the example method of FIG. 8. In this regard, the multi-track video processing module 230 may be configured to receive a multi-track video file at 800. The multi-track video file may comprise a plurality of alternative video tracks and one or more rule definitions. The plurality of alternative video tracks may include at least a first video track and a second video track. A first video segment on the first video track may present a different video scene than a second video segment on the second video track. The multi-track video processing module 230 may be further configured to determine at least one rule parameter at 810, and determine a target track and an associated target video segment at 820. The target track and the associated video segment may be determined by applying the at least one rule parameter to the one or more rule definitions. The target video track may be one of the plurality of alternative video tracks. Further, at 830, the multi-track video processing module 230 may be configured to cause playback of the target video segment on, for example, a display device of the apparatus 200.

According to some example embodiments, the multi-track video processing module 230 may additionally or alternatively be configured to cause playback of a given video segment on one of the plurality of alternative video tracks prior to causing playback of the target video segment, interrupt playback of the given video segment before playback of the given video segment is complete, and cause playback of the target video segment upon interrupting playback of the given video segment. Additionally or alternatively, the multi-track video processing module 230 may be configured to determine a target track by applying the at least one rule parameter to the one or more rule definitions while playback of the given video segment is occurring. Further, according to some example embodiments, the multi-track video processing module 230 may be configured to determine the at least one rule parameter based on a current context of a user or defined user preferences. Additionally or alternatively, the multi-track video processing module 230 may be configured to receive the multi-track video file, where the multi-track video file comprises at least one rules track having the one or more rule definitions. According to some example embodiments, the multi-track video processing module 230 may be additionally or alternatively configured to receive the multi-track video file, wherein one of the plurality of alternate video tracks is a default track for media players that do not support playback of multi-track video files.

Referring now to FIG. 7, a more specific example apparatus in accordance with various embodiments of the present invention is provided. The example apparatus of FIG. 7 is a mobile terminal 10 configured to communicate within a wireless network, such as a cellular communications network. The mobile terminal 10 may be configured to perform at least the functionality of the apparatus 200 as described herein. In some example embodiments, the mobile terminal 10 may be caused to perform the functionality of the multi-track video processing module 230 via the processor 20. In this regard, processor 20 may be an integrated circuit or chip configured similar to the processor 205 together with, for example, the I/O interface 206. Further, volatile memory 40 and non-volatile memory 42 may configured to support the operation of the processor 20 as computer readable storage media.

The mobile terminal 10 may further include an antenna 12, a transmitter 14, and a receiver 16, which may be included as parts of a communications interface of the mobile terminal 10. The speaker 24, the microphone 26, the display 28, and the keypad 30 may be included as parts of a user interface.

As described above, FIG. 8 illustrates flowcharts of example systems, methods, and/or computer programs stored on a non-transitory computer readable medium (e.g., computer program product) according to some example embodiments of the invention. It will be understood that each block or operation of the flowcharts, and/or combinations of blocks or operations in the flowcharts, can be implemented by various means. Means for implementing the blocks or operations of the flowcharts, combinations of the blocks or operations in the flowchart, or other functionality of example embodiments of the present invention described herein may include hardware, and/or a non-transitory computer-readable storage medium having one or more computer program code instructions, program instructions, or executable computer-readable program code instructions stored therein. In this regard, program code instructions may be stored on a memory device, such as memory device 210, of an example apparatus, such as example apparatus 200, and executed by a processor, such as processor 205. As will be appreciated, any such program code instructions may be loaded onto a computer or other programmable apparatus (e.g., processor 205, memory device 210, or the like) from a computer-readable storage medium to produce a particular machine, such that the particular machine becomes a means for implementing the functions specified in the flowcharts' block(s) or operation(s). These program code instructions may also be stored in a computer-readable storage medium that can direct a computer, a processor, or other programmable apparatus to function in a particular manner to thereby generate a particular machine or particular article of manufacture. The instructions stored in the computer-readable storage medium may produce an article of manufacture, where the article of manufacture becomes a means for implementing the functions specified in the flowcharts' block(s) or operation(s). The program code instructions may be retrieved from a computer-readable storage medium and loaded into a computer, processor, or other programmable apparatus to configure the computer, processor, or other programmable apparatus to execute operations to be performed on or by the computer, processor, or other programmable apparatus. Retrieval, loading, and execution of the program code instructions may be performed sequentially such that one instruction is retrieved, loaded, and executed at a time. In some example embodiments, retrieval, loading and/or execution may be performed in parallel such that multiple instructions are retrieved, loaded, and/or executed together. Execution of the program code instructions may produce a computer-implemented process such that the instructions executed by the computer, processor, or other programmable apparatus provide operations for implementing the functions specified in the flowcharts' block(s) or operation(s).

Accordingly, execution of instructions associated with the blocks or operations of the flowchart by a processor, or storage of instructions associated with the blocks or operations of the flowcharts in a computer-readable storage medium, support combinations of operations for performing the specified functions. It will also be understood that one or more blocks or operations of the flowcharts, and combinations of blocks or operations in the flowcharts, may be implemented by special purpose hardware-based computer systems and/or processors which perform the specified functions, or combinations of special purpose hardware and program code instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions other than those explicitly described above are also contemplated as may be set forth in some of the appended claims. Although specific terms are employed herein, they are used in a generic and descriptive sense only and not for purposes of limitation.

1. A method comprising:
receiving a multi-track video file comprising a plurality of alternative video tracks and one or more rule definitions, the plurality of alternative video tracks including at least a first video track and a second video track, wherein a first video segment on the first video track presents a different video scene than a second video segment on the second video track;
determining at least one rule parameter;
determining, by a processor, a target track and an associated target video segment selected from the plurality of alternative video tracks by applying the at least one rule parameter to the one or more rule definitions, the target video track being one of the plurality of alternative video tracks; and
causing playback of the target video segment.

2. The method of claim 1 further comprising:
causing playback of a given video segment on one of the plurality of alternative video tracks prior to causing playback of the target video segment; and
wherein causing playback of the target video segment includes:
interrupting playback of the given video segment before playback of the given video segment is complete, and
causing playback of the target video segment upon interrupting playback of the given video segment.

3. The method of claim 2, wherein determining a target track includes determining a target track by applying the at least one rule parameter to the one or more rule definitions while playback of the given video segment is occurring.

4. The method of claim 1 wherein determining the at least one rule parameter includes determining the at least one rule parameter based on a current context of a user or defined user preferences.

5. The method of claim 1, wherein receiving the multi-track video file includes receiving the multi-track video file, the multi-track video file comprising at least one rules track having the one or more rule definitions.

6. The method of claim 1, wherein receiving the multi-track video file includes receiving the multi-track video file, wherein one of the plurality of alternate video tracks is a default track for media players that do not support playback of multi-track video files.

7. An apparatus comprising at least one processor and at least one memory including computer program code, the at least one memory and the computer program code configured to, with the at least one processor, direct the apparatus at least to:
receive a multi-track video file comprising a plurality of alternative video tracks and one or more rule definitions, the plurality of alternative video tracks including at least a first video track and a second video track, wherein a first video segment on the first video track presents a different video scene than a second video segment on the second video track;
determine at least one rule parameter;
determine a target track and an associated target video segment selected from the plurality of alternative video tracks by applying the at least one rule parameter to the one or more rule definitions, the target video track being one of the plurality of alternative video tracks; and
cause playback of the target video segment.

8. The apparatus of claim 7, wherein the apparatus is further directed to:
cause playback of a given video segment on one of the plurality of alternative video tracks prior to causing playback of the target video segment; and
wherein the apparatus directed to cause playback of the target video segment includes being directed to:
interrupt playback of the given video segment before playback of the given video segment is complete, and
cause playback of the target video segment upon interrupting playback of the given video segment.

9. The apparatus of claim 8, wherein the apparatus directed to determine a target track includes being directed to determine a target track by applying the at least one rule parameter to the one or more rule definitions while playback of the given video segment is occurring.

10. The apparatus of claim 7, wherein the apparatus being directed to determine the at least one rule parameter includes being directed to determine the at least one rule parameter based on a current context of a user or defined user preferences.

11. The apparatus of claim 7, wherein the apparatus being directed to receive the multi-track video file includes being directed to receive the multi-track video file, the multi-track video file comprising at least one rules track having the one or more rule definitions.

12. The apparatus of claim 7, wherein the apparatus being directed to receive the multi-track video file includes being directed to receive the multi-track video file, wherein one of the plurality of alternate video tracks is a default track for media players that do not support playback of multi-track video files.

13. The apparatus of claim 7 further comprising a display device configured to present the target video segment during playback.

14. The apparatus of claim 13, wherein the apparatus comprises a mobile terminal.

15. At least one non-transitory computer-readable medium having computer program code stored thereon, the computer program code being configured to, when executed, direct an apparatus to at least:
receive a multi-track video file comprising a plurality of alternative video tracks and one or more rule definitions, the plurality of alternative video tracks including at least a first video track and a second video track, wherein a first video segment on the first video track presents a different video scene than a second video segment on the second video track;
determine at least one rule parameter;
determine a target track and an associated target video segment selected from the plurality of alternative video tracks by applying the at least one rule parameter to the one or more rule definitions, the target video track being one of the plurality of alternative video tracks; and
cause playback of the target video segment.

16. The at least one non-transitory computer-readable medium of claim 15, wherein the computer program code is further configured to direct the apparatus to:
cause playback of a given video segment on one of the plurality of alternative video tracks prior to causing playback of the target video segment; and
wherein the computer program code configured to direct the apparatus to cause playback of the target video segment includes computer program code configured to direct the apparatus to:
interrupt playback of the given video segment before playback of the given video segment is complete, and
cause playback of the target video segment upon interrupting playback of the given video segment.

17. The at least one non-transitory computer-readable medium of claim 16, wherein the computer program code configured to direct the apparatus to determine a target track includes computer program code configured to direct the apparatus to determine a target track by applying the at least one rule parameter to the one or more rule definitions while playback of the given video segment is occurring.

18. The at least one non-transitory computer-readable medium of claim 15, wherein the computer program code configured to direct the apparatus to determine the at least one rule parameter includes computer program code configured to direct the apparatus to determine the at least one rule parameter based on a current context of a user or defined user preferences.

19. The at least one non-transitory computer-readable medium of claim 15, wherein the computer program code configured to direct the apparatus to receive the multi-track video file includes computer program code configured to direct the apparatus to receive the multi-track video file, the multi-track video file comprising at least one rules track having the one or more rule definitions.

20. The at least one non-transitory computer-readable medium of claim 15, wherein the computer program code configured to direct the apparatus to receive the multi-track video file includes computer program code configured to direct the apparatus to being directed to receive the multi-track video file, wherein one of the plurality of alternate video tracks is a default track for media players that do not support playback of multi-track video files.

21.-26. (canceled)
